(19) United States
(12) Patent Application Publication
(10) Pub. No.: US 2026/0350298 A1
(43) Pub. Date: Nov. 5, 2026

(54) Generative Artificial Intelligence Systems and Methods for Converting Unstructured Forms into Structured Data Sets

(71) Applicant: Insurance Services Office, Inc., Jersey City, NJ (US)

(72) Inventors: Miao Li, New York, NY (US); Ashish Nangpal, Belle Mead, NJ (US); Deepika Vasu Kumar, Jersey City, NJ (US); Kishore Reddy Yaramala, Andhra Pradesh (IN); Sara Rachel Strohm, Bangor, ME (US); Pradeep Ghimire, North York (CA)

(73) Assignee: Insurance Services Office, Inc., Jersey City, NJ (US)

(21) Appl. No.: 19/662,433

(22) Filed: Apr. 29, 2026

Related U.S. Application Data
(60) Provisional application No. 63/798,234, filed on May 1, 2025.

(51) Int. Cl. G06F 40/174; G06N 20/20; G06V 30/414

(52) U.S. Cl. CPC G06F 40/174; G06N 20/20; G06V 30/414

(57) ABSTRACT

Generative artificial intelligence systems and methods for converting unstructured forms to structured data sets are provided. The system includes a document processor that executes a structured data generation software engine. The system receives and processes insurance policy and/or endorsements forms from one or more document source(s) that are in communication with the processor, and automatically converts unstructured insurance forms (including insurance policy forms and endorsement forms) to structured data sets using natural language processing and generative AI techniques. The system can effectively handle varied document formats, data types, and complex hierarchical structures present in insurance forms by converting such elements into structured data sets, thereby allowing for rapid and computationally-efficient searching, querying, data analysis, and analytics to be performed across a wide variety of insurance forms and unstructured data types.

### RELATED APPLICATIONS

The present application claims the benefit of U.S. Provisional Application Ser. No. 63/798,234 filed on May 1, 2025, the entire disclosure of which is expressly incorporated herein by reference.

### BACKGROUND

### Technical Field

The present disclosure relates generally to the field of generative artificial intelligence. More specifically, the present disclosure relates to generative artificial intelligence systems and methods for converting unstructured forms into structured data sets.

### Related Art

In the insurance field, insurance professionals and stakeholders often utilize forms for capturing insurance-related information. Such forms are often unstructured, in that they vary in format and content from form to form, and they often include disparate (and often, incompatible) data types, such as unstructured text, images, video files, etc. As a result, existing computer systems utilized in the insurance field can only process specific types of forms and cannot efficiently and effectively process forms of different formats and contents. For example, insurance forms often include varied formats, complex hierarchical relationships, and varied terminologies, which requires time-consuming and error-prone manual data conversion that lacks consistency. Still further, while there are some automation solutions that have been developed to date, such systems fail to maintain critical relationships among form elements, such as relationships among policy elements. As a result, this limitation severely limits the ability of computer systems to rapidly and efficiently process and share insurance-related data amongst a plurality of users.

The field of artificial intelligence, and in particular, generative artificial intelligence, is growing tremendously, and technologies in these areas are rapidly enhancing the speed with which useful data can be generated. However, such technologies have not yet effectively been incorporated into computer-based insurance forms processing and management systems, where there is a significant need for improving the speed and accuracy with which computer systems can process and share unstructured forms data. Indeed, there is a significant need for computer-based systems that can automatically and efficiently convers unstructured insurance (e.g., policy and endorsement) forms into standardized, consistent, searchable, queryable, analyzable, and comparable data sets and formats, so as to allow for systematic data analysis and analytics.

Accordingly, what would be desirable, but have not yet been provided, are generative artificial intelligence systems and methods for converting unstructured forms into structured data, which address the foregoing and other needs.

### SUMMARY

The present disclosure relates to generative artificial intelligence systems and methods for converting unstructured forms to structured data sets. The system includes a document processor that executes a structured data generation software engine. The system receives and processes insurance policy and/or endorsements forms from one or more document source(s) that are in communication with the processor, and automatically converts unstructured insurance forms (including insurance policy forms and endorsement forms) to structured data sets using natural language processing and generative AI techniques. The system can effectively handle varied document formats, data types, and complex hierarchical structures present in insurance forms by converting such elements into structured data sets, thereby allowing for rapid and computationally-efficient searching, querying, data analysis, and analytics to be performed across a wide variety of insurance forms and unstructured data types.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating the system of the present disclosure;

FIG. 2 is a flowchart illustrating overall processing steps carried out by the systems and methods of the present disclosure;

FIG. 3 is a flowchart illustrating step 32 of FIG. 2 in greater detail;

FIG. 4 is a flowchart illustrating step 34 of FIG. 2 in greater detail;

FIG. 5 is a flowchart illustrating step 36 of FIG. 2 in greater detail;

FIG. 6 is a flowchart illustrating step 38 of FIG. 2 in greater detail;

FIG. 7 is a flowchart illustrating step 40 of FIG. 2 in greater detail;

FIG. 8 is a flowchart illustrating step 42 of FIG. 2 in greater detail;

FIG. 9 is a flowchart illustrating step 44 of FIG. 2 in greater detail;

FIG. 10 is a flowchart illustrating step 46 of FIG. 2 in greater detail;

FIG. 11 is a flowchart illustrating step 48 of FIG. 2 in greater detail;

FIG. 12 is a diagram illustrating a sample software architecture capable of being utilized to implement the systems and methods of the present disclosure;

FIGS. 13-17 are screenshots illustrating user interface screens generated by the systems and methods of the present disclosure;

FIG. 18 is a flowchart illustrating additional processing steps carried out by the systems and methods of the present disclosure for determining and illustrating correspondences between forms; and

FIGS. 19-22 are screenshots illustrating user interface screens generated by the systems and methods of the present disclosure, wherein correspondences between forms are identified and displayed by the system.

### DETAILED DESCRIPTION

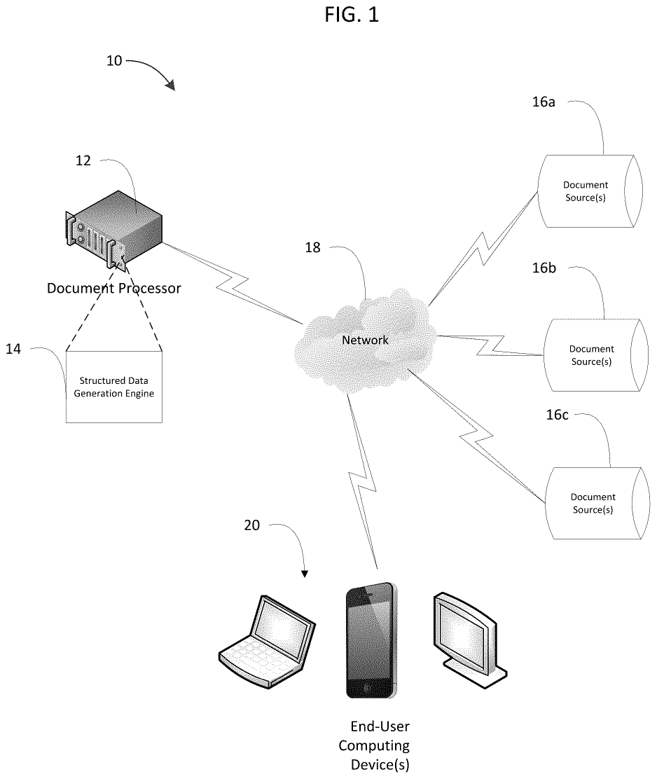

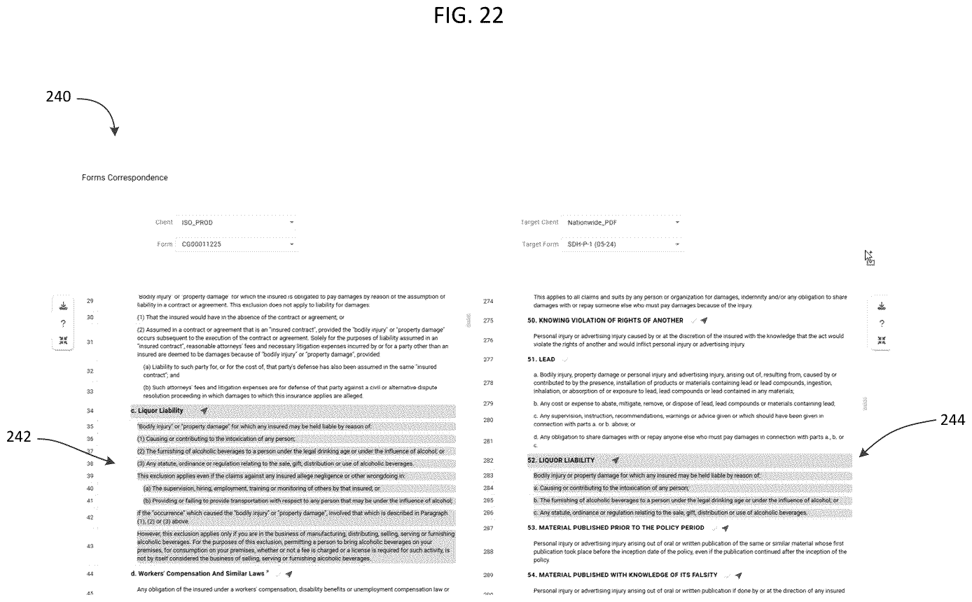

The present disclosure relates to generative artificial intelligence systems and methods for converting unstructured forms to structured data sets, as described in detail below in connection with FIGS. 1-22.

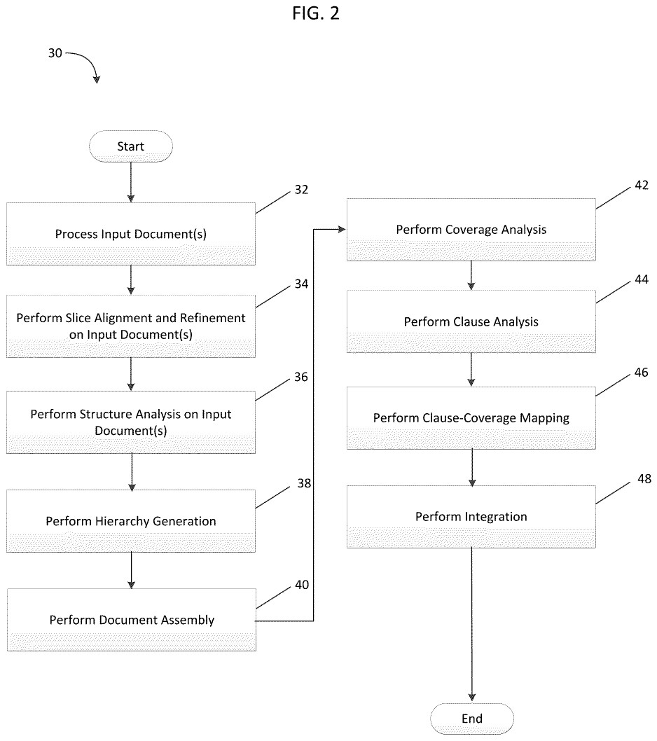

FIG. 1 is a diagram illustrating the system of the present disclosure, indicated generally at 10. The system 10 includes a document processor 12 that executes a structured data generation software engine 14. The document processor 12 and the structured data generation software engine receive 14 and process insurance policy and/or endorsements forms from one or more document source(s) 16a-16c that are in communication with the processor 12 via a network 18, such as the Internet, a local area network, a wide area network, a cellular data communications network, an intranet, or other suitable type of network. As will be discussed in greater detail below in connection with FIGS. 2-12, the processor 12 and the engine 14 are an artificial intelligence (AI) powered system that automatically converts unstructured insurance forms (including insurance policy forms and endorsement forms) to structured data sets using natural language processing and generative AI techniques. Such features allow the system to effectively handle varied document formats, data types, and complex hierarchical structures present in insurance forms by converting such elements into structured data sets, to allow for rapid and computationally-efficient searching, querying, data analysis, and analytics to be performed across a wide variety of insurance forms and unstructured data types.

The processor 12 could be any suitable computing device capable of executing the engine 14 and performing the steps discussed herein, including, but not limited to, a desktop computer, a laptop computer, a tablet computer, a smart phone, a server, a cloud-based computing platform, or other suitable type of computing system or environment. The engine 14 could be embodied as non-transitory, computer-readable instructions stored in a suitable memory or storage medium and executable by the processor 12, and could be coded in any suitable high-or low-level computer programming language, including, but not limited to, C, C++, C #, Java, Python, or any other suitable language. Moreover, the engine 14 could be embodied as a hardware device such as a field-programmable gate array (FPGA), an application-specific integrated circuit (ASIC), or other suitable hardware device. The processor 12 can communicate with one or more end-user computer devices 20, such as desktop computers, laptop computer, tablet computers, smart phones, etc., so that the users of such devices can interact with the systems and methods of the present disclosure using a suitable user interface, which could be web-based (e.g., hosted by the processor 12 or other device such as a web server) and/or by way of a customized software application executed by the devices 12. The end-user devices 20 can communicate with the processor 12 via the network 18. Still further, the engine 14 could be executed directly by the end-user devices 20, in which circumstance the processor 12 need not be provided and the end-user computing devices 20 can communicate with the document sources 16a-16c via the network 18. The document sources 16a-16c store insurance policy and endorsement information processed by the systems and methods of the present disclosure.

FIG. 2 is a flowchart illustrating overall processing steps, indicated generally at 30. carried out by the systems and methods of the present disclosure. In step 32, the system retrieves insurance forms documents (including, but not limited to, policy forms and endorsement forms) from a suitable data source, such as from one or more of the document sources 16a-16c. Next, in step 34, the performs slice alignment and refinement processes on the input documents. Then, in step 36, the system performs structure analysis on the input documents. In step 38, the system generates a hierarchy of one or more of the input documents. Next, in step 40, the system performs document assembly, and in step 42, the system performs coverage analysis. In step 44, the system performs clause analysis on the input documents, and in step 46, the system performs clause-to-coverage mapping. Finally, in step 48, the system integrates the results and displays them to the user in a customized user interface displayed on one or more of the end-user devices 20 of FIG. 1.

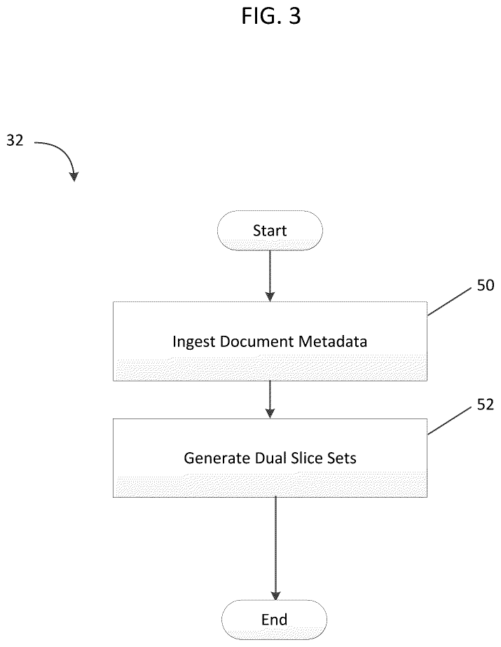

FIG. 3 is a flowchart illustrating step 32 of FIG. 2 in greater detail. As noted above, in step 32, the system processes one or more input documents such as an insurance policy form or an endorsement form. First, in step 50, the system extracts and ingests document metadata from the one or more input documents. This can include, but is not limited to, insurance form numbers, lines of business (LOB) data, and, if applicable, portable document format (PDF) metadata from the one or more input documents (in the event that such documents are stored as PDF files). Then, in step 52, the system generates two (dual) slice sets, including HTML slices (e.g., Aspose HTML slices) and slices applicable to direct PDF file parsing. By term “slicing,” it is meant a data analytics process for extracting a specific subset of data (or, smaller subsets of data) from a larger data set. Each section title could be determined by the system to be a slice, and each paragraph of text content could also be determined by the system to be a slice.

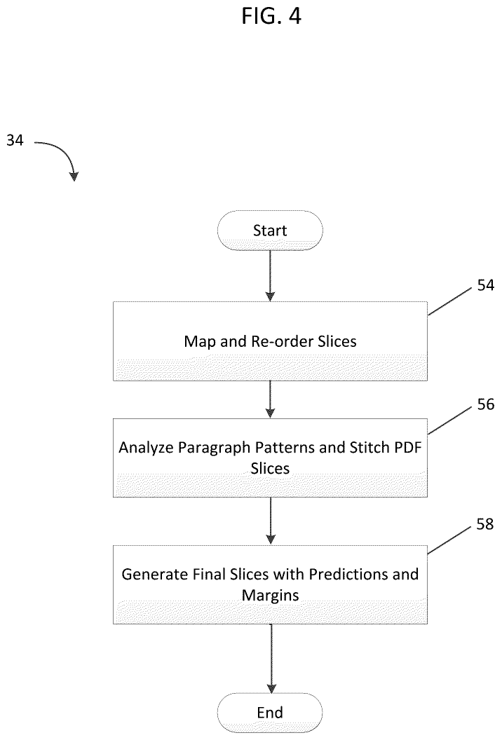

FIG. 4 is a flowchart illustrating step 34 of FIG. 2 in greater detail. As mentioned above, in step 34, the system the system performs slice alignment and refinement on the input documents. In step 54, the system maps and re-orders the dual slice sets generated in step 32 of FIG. 2. In this step, any invalid content order or content loss with respect to the original document is corrected. Then, in step 56, the system analyzes paragraph patterns and stitches PDF slices together. Then, in step 58, the system generates final slices that include predictions and margins. More specifically, in step 58, using the sets of slices, the system analyzes the gap between the paragraphs or section titles and subsequent paragraphs. Each slice (e.g., of a PDF file) is based on each line (e.g., each line of the paragraph), and using gap analysis, the system stitches the lines together to create a slice that is based on a paragraph. The slices are then passed through a customized machine learning model (e.g., a two-class slice classification pre-trained Random Forest Model) to classify the slice as being either a header type or a content type.

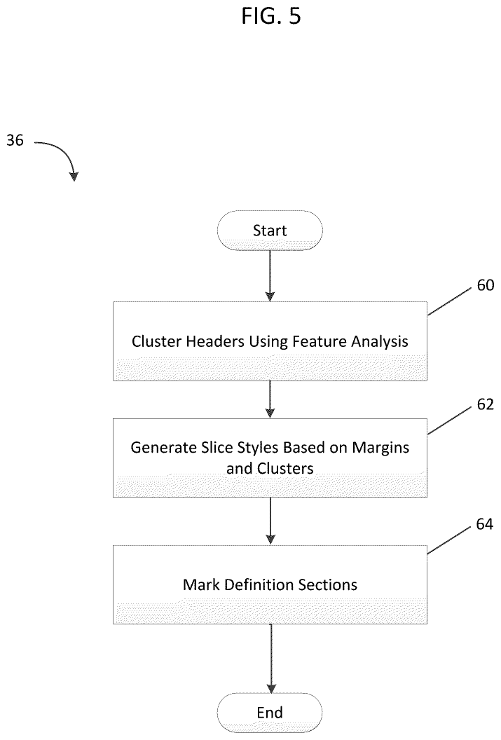

FIG. 5 is a flowchart illustrating step 36 of FIG. 2 in greater detail. As noted above, in step 36, the system performs structure analysis on the input documents in order to generate an overall structure of the input documents. In step 60, the system clusters headers of the input document (e.g., section headers, topic headers, etc.) using feature analysis whereby headers that share statistically significant features (e.g., header type, format, length, content, etc.) are clustered together using a clustering algorithm, such as a K-means clustering algorithm. Then, in step 62, the system generates slice styles based on detected margins and the clusters identified in step 60. More specifically, slice styles are labels or codes which are generated by the system and assigned to a slice, and which represent a slice category (e.g., header or footer). They can start with a bullet, and then can include the level of the slice (e.g., the indentation depth of the slice). For example, a slice style could be defined by the system and entitled “blockhd2” which signifies that the slice is a non-bulleted slice (indicated by the term “block”), the slice is a header type of slice, and has an indentation level of 2. As another example, the system could define a slice style of “outlinetxt1” which signifies that the slice is a bulleted slice (indicated by the term “outline”), the slice is a content type of slice (indicated by the term “txt”), and has an indentation level of 1. Finally, in step 64, the system marks definition sections within the document.

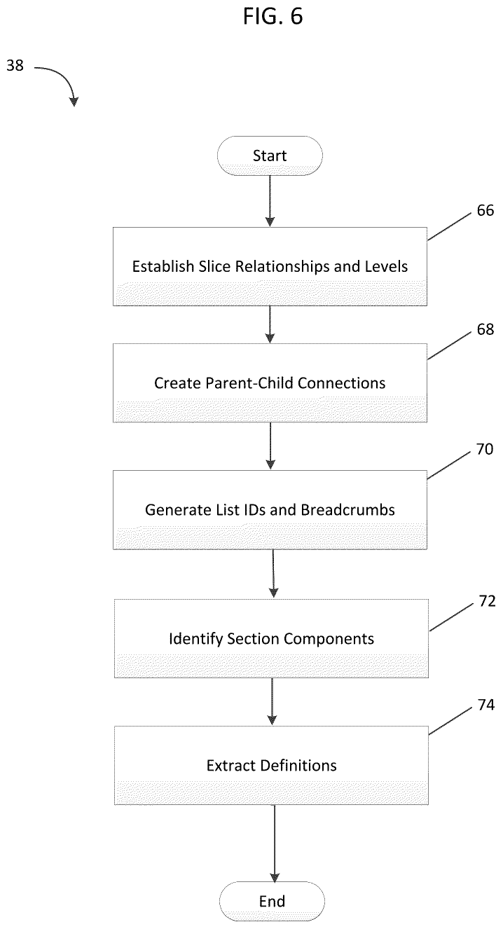

FIG. 6 is a flowchart illustrating step 38 of FIG. 2 in greater detail. As noted above, in step 38, the system generates a hierarchy for a given insurance form (document). In step 66, the system establishes slice relationships and labels for each slice. Then, in step 68, the system creates parent-child connections between sections of the document. Next, in step 70, the system generates a list of identifiers and “breadcrumbs” which are control elements used as navigational aids in traversing the document at issue. In step 72, the system identifies section components of the document, an in step 74, the system extracts definitions from the document. The slice relationships, labels, parent-child connections, identifier lists, breadcrumbs, and section components are used by the system to construct the overall hierarchy of the document.

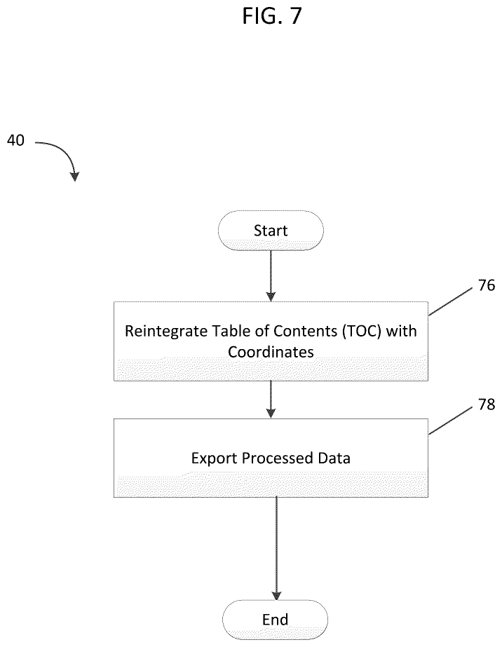

FIG. 7 is a flowchart illustrating step 40 of FIG. 2 in greater detail. As mentioned above, in step 40, the system performs document assembly. In step 76, the system reintegrates a table of contents for the document with coordinates within the document. Then, in step 78, the system exports processed data. More specifically, the table of contents slices, which were captured at the beginning of the process and are excluded from the other steps discussed herein, are inserted into the final collection of slices. Data that is intermittent or redundant in the slices is removed by the system, and consistent data types are assigned to respective attributes.

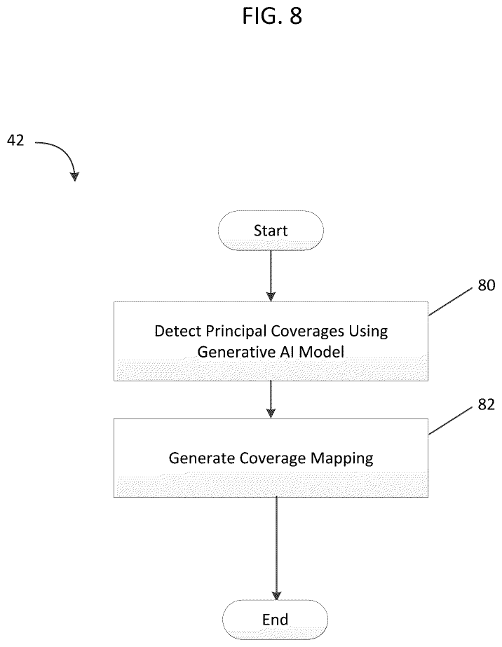

FIG. 8 is a flowchart illustrating step 42 of FIG. 2 in greater detail. As noted above, in step 42, the system performs coverage analysis on the input document. In step 80, the system detects principal insurance coverages that are present in the input document using one or more pre-trained generative artificial intelligence (AI) models. The models are pre-trained large language models (LLMs) that utilize API calls for communication. Then, in step 82, the system generates a coverage mapping for the document. The mapping maps the names of the major coverages to one or more standard names (e.g., one or more standard names defined by Insurance Services Office, Inc.). For example, one standard may be called “personal and advertising injury liability coverage” but insurance forms may refer to the same standard by a different name, such as “non-physical injury coverage.” Advantageously, the systems and methods of the present disclosure harmonize these differences, allowing computer systems to more rapidly and accurately process insurance forms despite the presence of such differences.

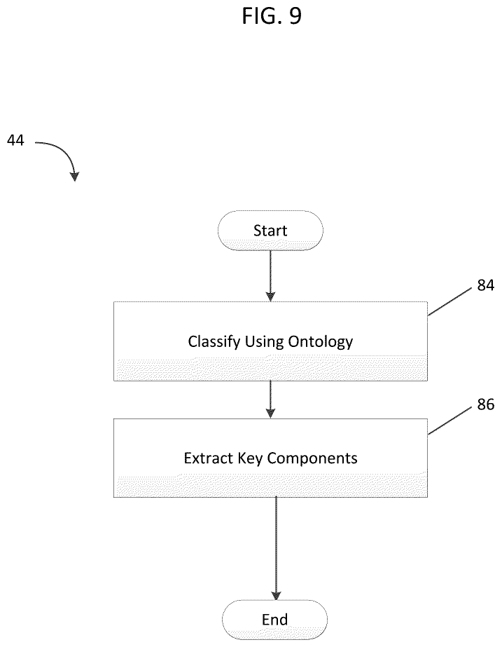

FIG. 9 is a flowchart illustrating step 44 of FIG. 2 in greater detail. As noted above, in step 44, the system performs clause analysis on the input document. In step 84, the system classifies each clause present in the input document using one or more pre-defined and stored ontologies. Ontologies codify categories, properties, and/or relationships between concepts, data, or entities in the input documents. For example, an insurance form component ontology could specify categories and relationships for insurance forms. Further, insurance forms can include components that fall into specific categories such as coverages, conditions, insuring agreements and definitions, and an ontology could be defined reflecting these categories and associated components. Still further, some categories may have more specific subcategories (e.g. additional conditions, optional coverages, etc.), which could also be accounted for by one or more ontologies. Then, in step 86, the system extracts key components from the classified clauses.

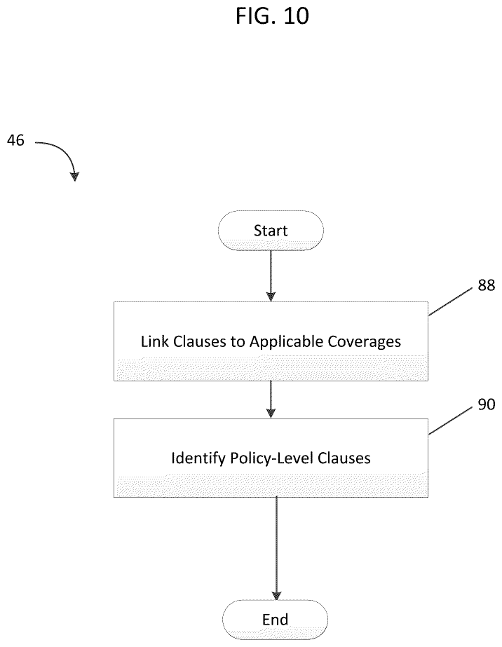

FIG. 10 is a flowchart illustrating step 46 of FIG. 2 in greater detail. As noted above, in step 46, the system performs clause-to-coverage mapping in connection with the input document. In step 88, the system links clauses to applicable coverages, using one or more pre-defined rules stored in the system. Then, in step 90, the system identifies policy-level clauses that are relevant to the applicable coverages, and links them together. Importantly, the system generates a new, structured data structure from the unstructured input data which includes selected data slices taken from the input document, clauses extracted from the input document, and linkages of the clauses to their principal coverages. This data structure allows the system to rapidly and efficiently navigate through unstructured insurance forms, with reduced computational overhead and increased processing speed, thereby greatly improving the functioning of the computer system in handling unstructured insurance form data. As a result, the system has improved form processing efficiency and accuracy compared to existing systems and methods; creates searchable, queryable, and rapidly analyzable database elements; and produces consistent, structured data suitable for downstream use (e.g., processing by other computer systems in communication with the system of the present disclosure) and/or use cases, such as form analysis, concept searches, and form comparison tasks.

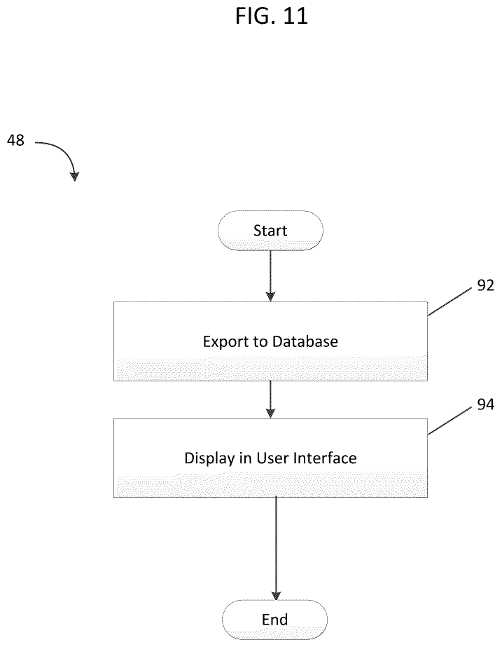

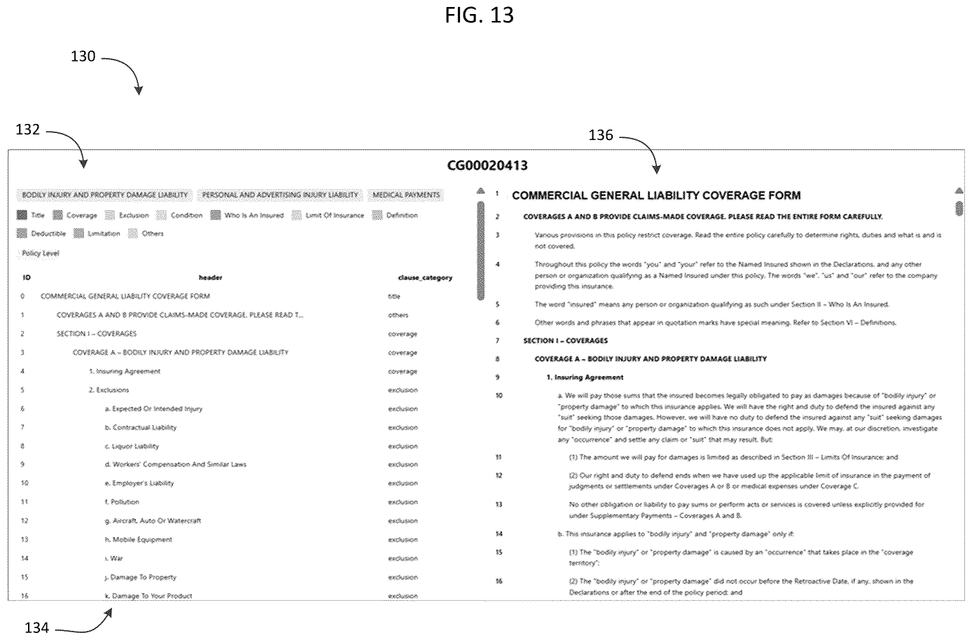

FIG. 11 is a flowchart illustrating step 48 of FIG. 2 in greater detail. As mentioned above, in step 48, the system integrates the results generated by the system and displays them to a user in one or more user interface screens. Specifically, in step 92, the system exports the structured data generated by the system to one or more databases, and in step 94, the system displays the results on or more user interface screens, such as the screens discussed in connection with FIGS. 13-17.

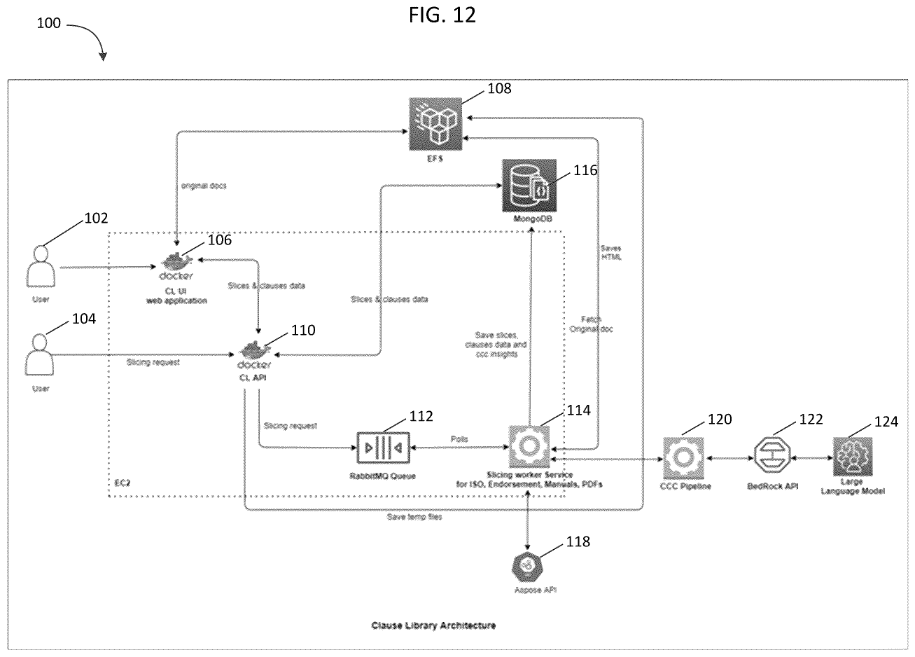

FIG. 12 is a diagram illustrating a sample software architecture capable of being utilized to implement the systems and methods of the present disclosure, indicated generally at 100. The software architecture 100 includes a user interface web generation application 106 that generates the user interface screens discussed below in connection with FIGS. 13-17 and displayed to the user 102 for interaction therewith, an application programming interface (API) module 110 which allows the functions provided by the systems and methods of the present disclosure to be called directly using API calls (e.g., calls issued by a programmer/user 104) without requiring user interface screens, a data slicing queue 112, a data slicing worker service 114, a database 116, an encrypted file system (EFS) 108 which can securely store insurance forms data as well as outputs generated by the systems/methods of the present disclosure, a multi-format file management module (e.g., such as the Aspose system) 118 that allows the system to receive and process files in various formats via API calls/responses, a forms processing pipeline module 120 which allows for multiple forms to be processed in parallel in a pipeline fashion, a large language model API 122 (such as the Bedrock API), and one or more AI large language models (LLMs) 124 that provide the generative AI services discussed herein.

FIGS. 13-17 are screenshots illustrating user interface screens generated by the systems and methods of the present disclosure. As shown in FIG. 13, a first user interface screen 130 generated by the system includes a display area 132 that displays a document hierarchy generated by the system and relating to an insurance form, a plurality of user-selectable hierarchy of elements 134 that can be clicked on by the user, and a related insurance form display area 136 which displays an insurance form corresponding to the document hierarchy shown in display area 132. The hierarchy shown in area 132 is a structured data set representation of the unstructured form displayed in the display area 136, and allows the user to very rapidly and easily locate specific types of information in the unstructured form displayed in the area 136, such as, but not limited to, policy-level elements/concepts, titles, coverages, exclusions, identifies of insured individuals, limits of insurance, definitions, deductibles, limitations, and other elements/concepts. It is noted that the area 132 could also include colored banners which reflect the major types of coverage detected in an insurance form, such as bodily injury, property damage, etc. A second row of banners could indicate the clause categories, and a third row of banners could indicate the policy-level clauses. Each of these banners are “clickable” in the user interface, and by clicking on a particular banner, the system will automatically locate and highlight clauses in the displayed text which correspond to the clauses indicated by the banners.

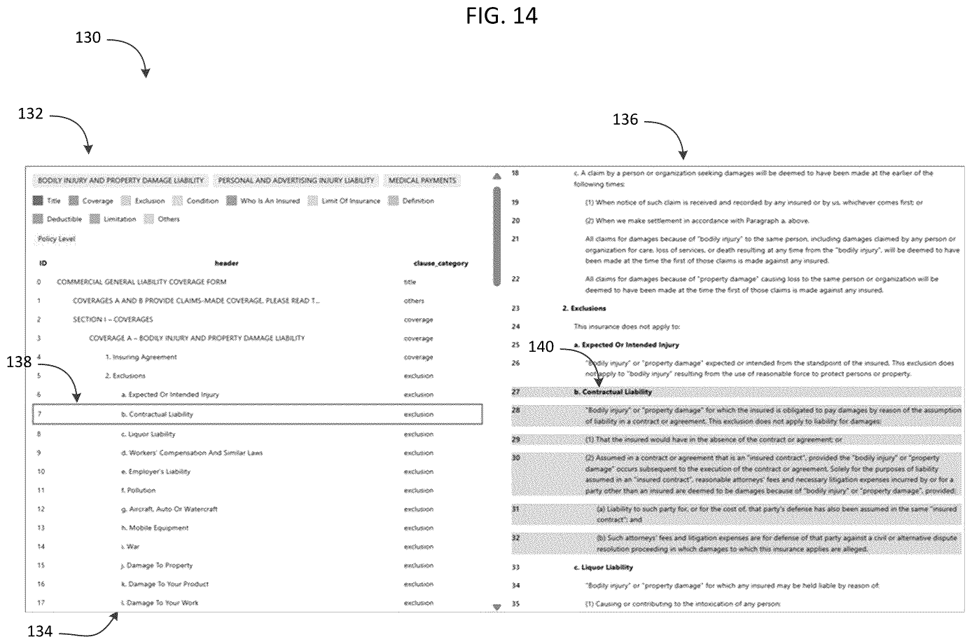

As shown in FIG. 14, when the user clicks on one of the elements/concepts 138 in the hierarchy of elements 134 displayed in the area 132 (here, the user has clicked on the element/concept called “Contractual Liability”), the system rapidly locates and highlights language in the unstructured form displayed in the area 136 and displays this information to the user in the highlighted portions illustrated by element 140 in FIG. 14. More specifically, the highlighted text 140 corresponds to text in the unstructured form of the display area 136 that relates to contractual liability provisions. In this fashion, the system very rapidly searches for, locates, and displays relevant text from unstructured documents, allowing for rapid analysis of insurance forms.

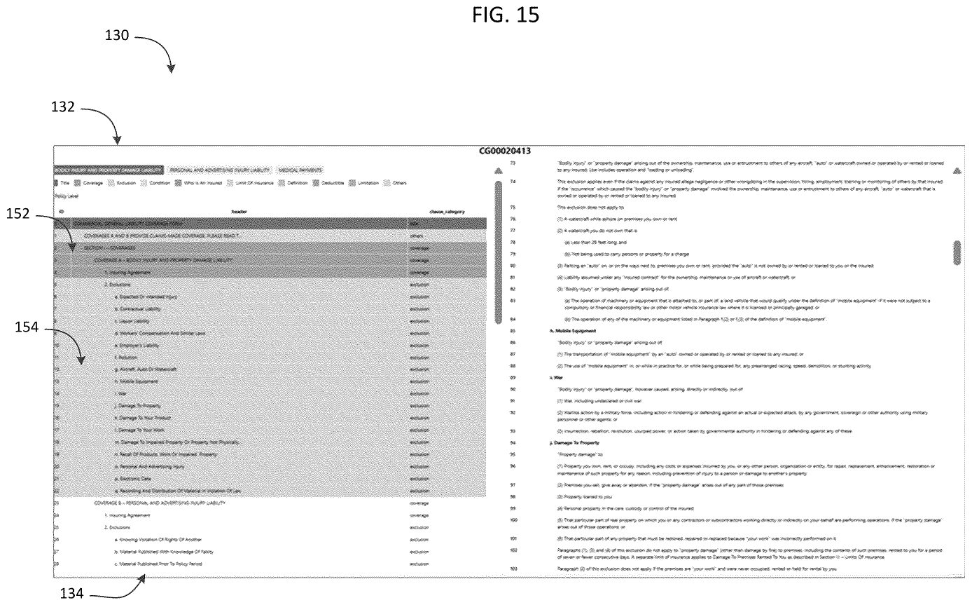

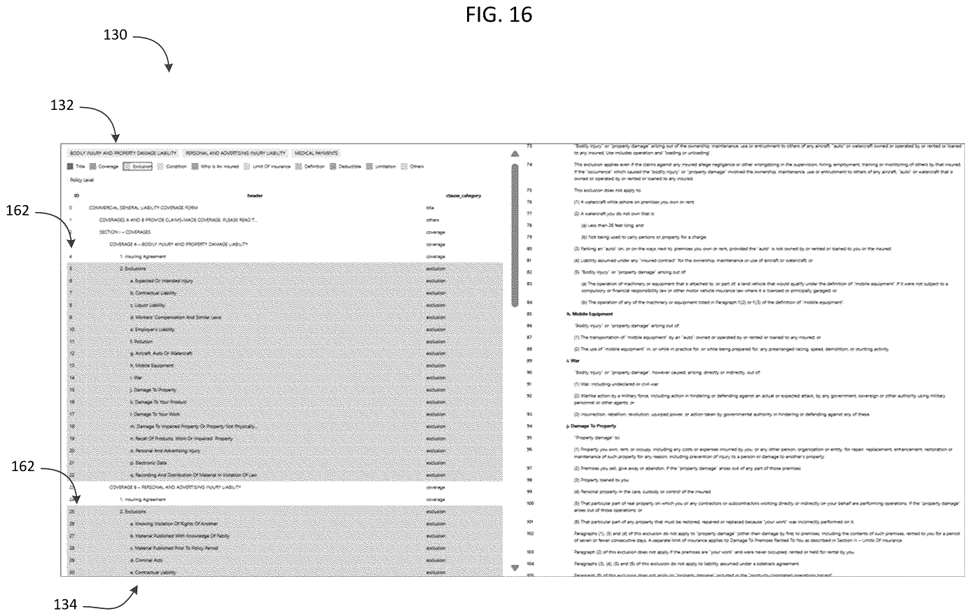

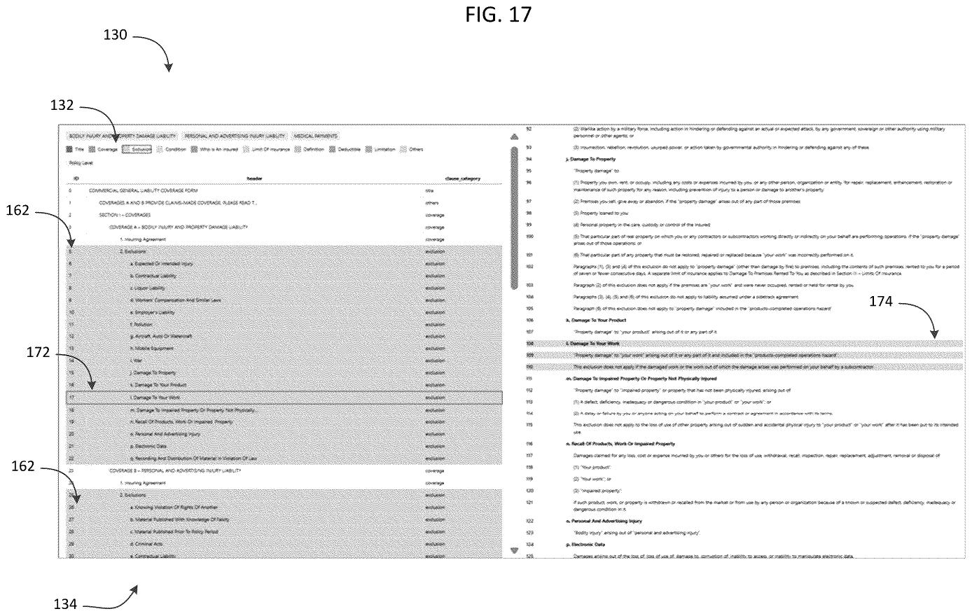

As shown in FIG. 15, one or more of the portions of the document hierarchy 134 can be highlighted in specific colors (or using other indicia) so that related hierarchy elements can be easily identified. Here, all of the clauses that apply to “bodily injury and property damage coverage” clause category are highlighted by colors; among them, clauses that are identified as “coverage” clause category are highlighted in a first color 152 (e.g., blue) and clauses that are identified as an “exclusion” clause category are highlighted in a second color 154 (e.g., yellow), so that the hierarchy 134 can itself be easily navigated by the user. This is also shown in FIG. 16, where the user has selected a specific clause category of “exclusion” and all of the clauses in the form that are classified as exclusion clauses are automatically colored in the same color 162 (e.g., yellow). Finally, as shown in FIG. 17, if a user clicks on one of the hierarchy elements 172 (corresponding to an exclusion relating to damage to a workplace), the system automatically identifies and highlights language 174 in the unstructured policy corresponding to the element 172 (e.g., policy language that corresponds to damage in the workplace).

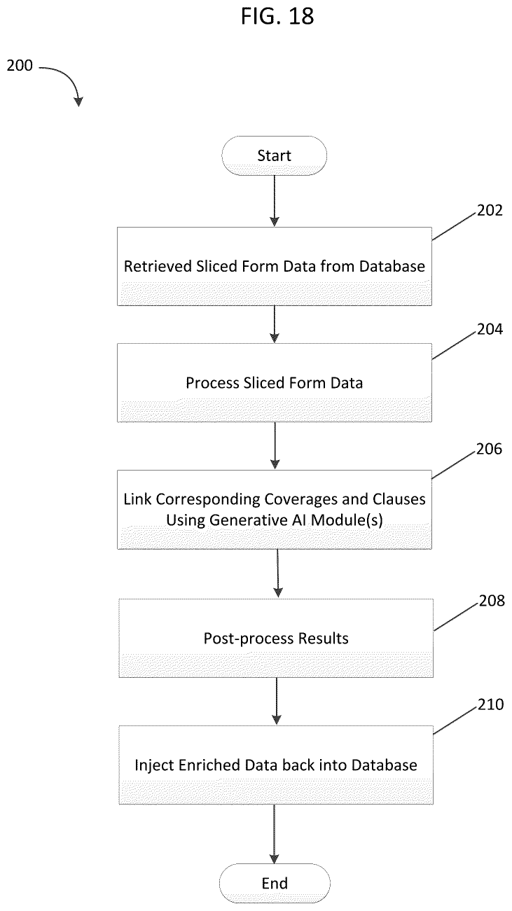

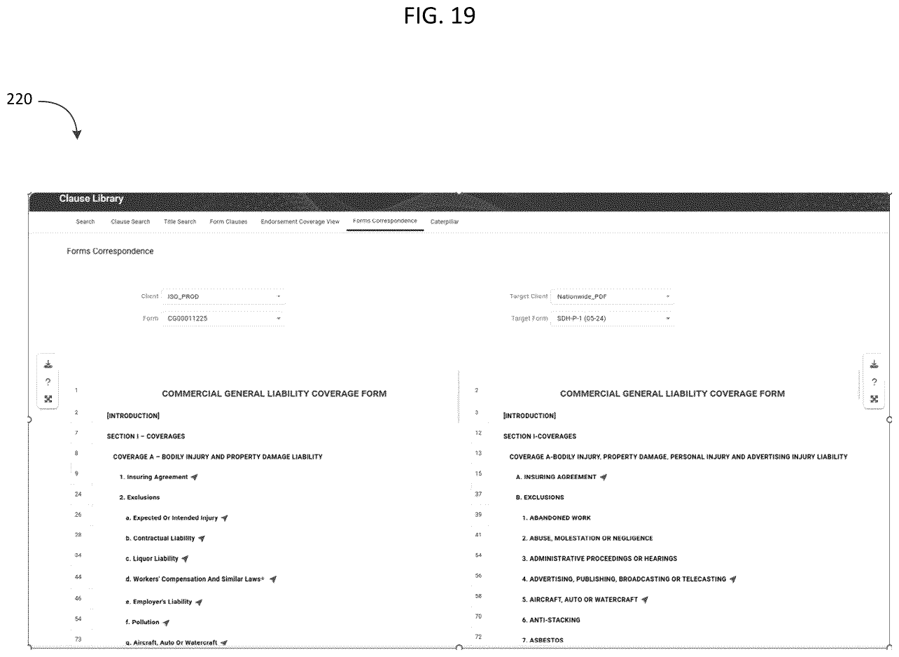

FIG. 18 is a flowchart illustrating additional processing steps, indicated generally at 200, carried out by the systems and methods of the present disclosure for determining and illustrating correspondences between forms. Advantageously, the steps 200 allow the system to quickly and automatically identify correspondences between forms, e.g., clauses, provisions, and/or other language, that are related between forms, even in circumstances where the clauses, provisions, and/or other language are conceptually related and/or relevant but are not textually identical. In step 202, the system retrieves sliced form data from the database, such as one or more of the database discussed above. Next, in step 204, the system processes the sliced form data as discussed in connection with FIG. 2. In step 206, the system links corresponding coverages and clauses in the sliced form data using one or more generative AI models. In step 208, the system processes the results of the one or more generative AI models (e.g., performing quality checks on the results, verifying that the proposed coverages and clauses to be linked are appropriate for linking, etc.), and in step 210, the results (e.g., the corresponding coverages and clauses that the system determines should be linked) are fed back into the database, for future retrieval, processing, and/or display to the user (e.g., discussed in detail below in connection with FIGS. 19-22.

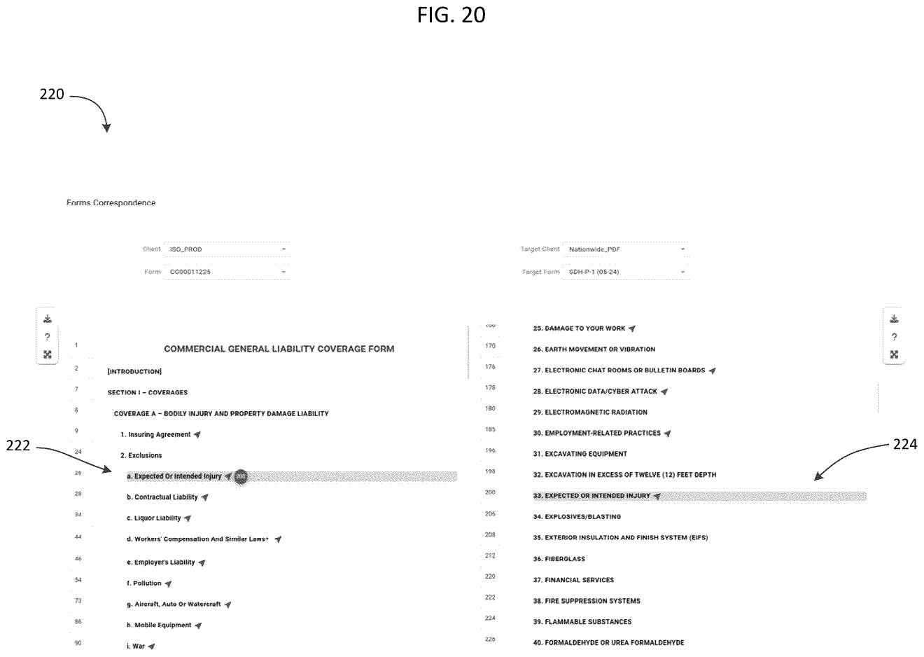

FIGS. 19-22 are screenshots illustrating user interface screens generated by the systems and methods of the present disclosure, wherein correspondences between forms are identified and displayed by the system (as discussed above in connection with FIG. 18). As can be seen in FIG. 19, a user interface screen 220 is generated by the system and displays two forms side-by-side-a first form (e.g., a first commercial general liability form) is displayed on the left, and a second form (e.g., a different version of the commercial general liability form) is displayed on the right. As shown in FIG. 20, the user can click on a desired section, portion, or heading of the first form displayed on the left using cursor 222. In response, the system automatically identifies a corresponding portion in the second form displayed on the right by highlighting 224 which highlights a section, portion, or heading of the second form on the right that includes information corresponding to the section, portion or heading selected in the first form using the cursor 222. Advantageously, the system can automatically identify correspondences between sections, portions, or headings of the two forms that may not be textually identical, but which include concepts, provisions, and/or other attributes that are conceptually related and/or relevant.

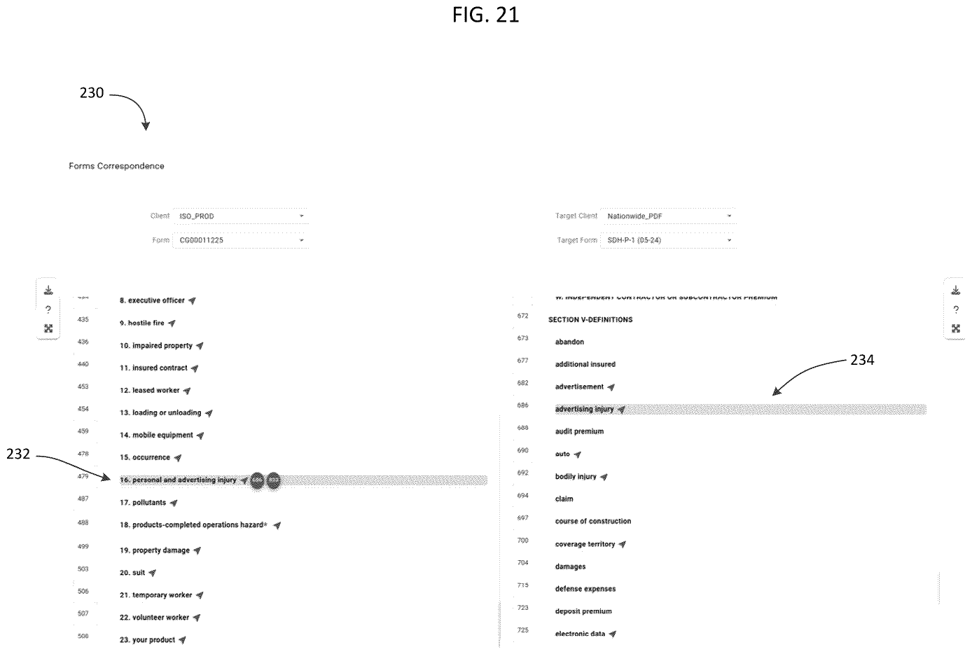

As shown in FIG. 21, the user interface screen 230 displays form headings or topics in a first form displayed on the left of the screen 230, which can be selected by the user using cursor 232. When the user does so, the system automatically identifies and highlights, using highlighting 234, a heading or topic in the second form displayed on the right of the screen 230 which corresponds to the heading or topic selected in the first form. As can be seen, the topics are not textually identical-that is, the topic selected by the user in the first form using the cursor 232 is entitled “personal and advertising injury” while the corresponding topic highlighted in highlighting 234 and automatically identified by the system is entitled “advertising injury.” The system thus allows for form correspondences to be identified where text does not match, but where concepts and/or other attributes of two forms are related and/or relevant to each other. This allows for rapid identification and comparison of forms using a customized interface, “sliced” form data (as discussed hereinabove) generated by the system, and easy-to-navigate visualization of related topics in forms, thereby greatly improving the speed of computer systems to identify and visualize related form provisions.

Finally, as shown in the user interface screen 240 displayed in FIG. 222, the system allows a user to compare not only headings of forms, but also whole portions of text between forms to identify relevant provisions in other forms. As shown, the interface screen 240 displays a first form on the left of the screen 240, and using the cursor 242, the user can select all of the text of the form relating to liquor liability. In response, the system automatically locates and highlights, using highlighting 244, relevant text in a second form displayed on the right of the screen 240 that is conceptually related and/or relevant to the text highlighted by the user using cursor 242. As can be seen, the formatting and content of the highlighted portion in the second form is substantially different than the text selected by the user (using the cursor 242) in the first form, but is conceptually relevant to the text selected by the user. As a result, the system greatly improves the speed and accuracy of computer-based searching, allowing for the rapid and automatic identification of conceptually related and/or relevant portions of forms in instances where the language of two forms may be substantially different.

Having thus described the systems and methods in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A generative artificial intelligence system for converting unstructured forms into structured data sets, comprising:
a document processor; and
a structured data generation software engine executed by the document processor, the structured data generation software engine causing the processor to perform steps of:
receiving an input form document;
processing the input form document to slice the input form document into a plurality of slice sets;
processing the plurality of slice sets to perform slice alignment and refinement;
processing the input form document to perform structure analysis on the input form document and generate a hierarchy of the input form document;
performing document assembly using the hierarchy of the input form document;
processing the input form document to perform coverage analysis on the input form document using a pre-trained large language model (LLM);
processing the input form document to perform clause analysis on the input form document;
performing clause-to-coverage mapping using results of the coverage analysis and the clause analysis; and
generating and displaying a customized user interface display that displays the hierarchy in a first display area and the input form document in a second display area adjacent to the first display area, the first display area allowing the user to select a coverage or a clause category and the system automatically identifying and displaying a clause of the input form document in the second display area that corresponds to the coverage or clause category selected by the user in the first display area.

2. The system of claim 1, wherein the plurality of slice sets comprises a hypertext markup language (HTML) slice and a slice suitable for portable document format (PDF) file parsing.

3. The system of claim 2, wherein the step of processing the plurality of slice sets to perform slice alignment and refinement further comprises:
mapping and re-ordering the plurality of slice sets;
analyzing paragraph patterns and stitching PDF slices together; and
generating final slices that include predictions and margins.

4. The system of claim 3, wherein the step of mapping and re-ordering the plurality of slice sets comprises correcting any invalid content order or content loss with respect to an original document.

5. The system of claim 3, wherein the step of generating the final slices comprises analyzing gaps between paragraphs or gaps between section titles and subsequent paragraphs.

6. The system of claim 5, wherein the processor performs a step of processing the final slices through a machine learning model to classify the slice as being either a header type or a content type.

7. The system of claim 6, wherein the machine learning model comprises a two-class slice classification pre-trained Random Forest Model.

8. The system of claim 1, wherein the step of performing structure analysis on the input form document comprises:
clustering headers of the input form document using a clustering algorithm;
generating slice styles based on detected margins and clusters; and
marking definition sections within the input form document.

9. The system of claim 8, wherein the step of generating the hierarchy comprises:
establishing slice relationships and labels for each slice;
creating parent-child connections between sections of the input form document;
generating a list of identifiers and control elements used as navigational aids in traversing the input form document;
identifying section components of the input form document; and
extracting definitions from the input form document.

10. The system of claim 1, wherein the step of performing document assembly comprises reintegrating a table of contents for the input form document with coordinates within the input form document.

11. The system of claim 1, wherein the step of processing the input form document to perform clause analysis on the input form document comprises classifying each clause present in the input form document using one or more pre-defined ontologies and extracting components from each classified clause.

12. The system of claim 1, wherein the step of performing clause-to-coverage mapping comprises linking clauses to applicable coverages using one or more pre-defined stored rules, identifying policy-level clauses that are relevant to the applicable coverages, and linking the clauses to the coverages.

13. The system of claim 1, wherein the processor performs steps of determining correspondences between a first form and a second form, and displaying the correspondences between first form and the second form in the customized user interface display.

14. A generative artificial intelligence method for converting unstructured forms into structured data sets, comprising steps of:
receiving by a document processor an input form document;
processing by the document processor the input form document to slice the input form document into a plurality of slice sets;
processing by the document processor the plurality of slice sets to perform slice alignment and refinement;
processing by the document processor the input form document to perform structure analysis on the input form document and generate a hierarchy of the input form document;
performing by the document processor document assembly using the hierarchy of the input form document;
processing by the document processor the input form document to perform coverage analysis on the input form document using a pre-trained large language model (LLM);
processing by the document processor the input form document to perform clause analysis on the input form document;
performing by the document processor clause-to-coverage mapping using results of the coverage analysis and the clause analysis; and
generating and displaying by the document processor a customized user interface display that displays the hierarchy in a first display area and the input form document in a second display area adjacent to the first display area, the first display area allowing the user to select a coverage or a clause category and the system automatically identifying and displaying a clause of the input form document in the second display area that corresponds to the coverage or clause category selected by the user in the first display area.

15. The method of claim 14, wherein the plurality of slice sets comprises a hypertext markup language (HTML) slice and a slice suitable for portable document format (PDF) file parsing.

16. The method of claim 15, wherein the step of processing the plurality of slice sets to perform slice alignment and refinement further comprises:
mapping and re-ordering the plurality of slice sets;
analyzing paragraph patterns and stitching PDF slices together; and
generating final slices that include predictions and margins.

17. The method of claim 16, wherein the step of mapping and re-ordering the plurality of slice sets comprises correcting any invalid content order or content loss with respect to an original document.

18. The method of claim 16, wherein the step of generating the final slices comprises analyzing gaps between paragraphs or gaps between section titles and subsequent paragraphs.

19. The method of claim 16, further comprising processing by the document processor the final slices through a machine learning model to classify the slice as being either a header type or a content type.

20. The method of claim 19, wherein the machine learning model comprises a two-class slice classification pre-trained Random Forest Model.

21. The method of claim 14, wherein the step of performing structure analysis on the input form document comprises:
clustering headers of the input form document using a clustering algorithm;
generating slice styles based on detected margins and clusters; and
marking definition sections within the input form document.

22. The method of claim 21, wherein the step of generating the hierarchy comprises:
establishing slice relationships and labels for each slice;
creating parent-child connections between sections of the input form document;
generating a list of identifiers and control elements used as navigational aids in traversing the input form document;
identifying section components of the input form document; and
extracting definitions from the input form document.

23. The method of claim 14, wherein the step of performing document assembly comprises reintegrating a table of contents for the input form document with coordinates within the input form document.

24. The method of claim 14, wherein the step of processing the input form document to perform clause analysis on the input form document comprises classifying each clause present in the input form document using one or more pre-defined ontologies and extracting components from each classified clause.

25. The method of claim 14, wherein the step of performing clause-to-coverage mapping comprises linking clauses to applicable coverages using one or more pre-defined stored rules, identifying policy-level clauses that are relevant to the applicable coverages, and linking the clauses to the coverages.

26. The method of claim 14, further comprising determining by the processor correspondences between a first form and a second form, and displaying the correspondences between first form and the second form in the customized user interface display.
